(19) United States
(12) Patent Application Publication
(10) Pub. No.: US 2006/0133494 A1
(43) Pub. Date: Jun. 22, 2006

(54) Image decoder with context-based parameter buffer

(76) Inventors: Rahul Saxena, Sunnyvale, CA (US); Munsi A. Haque, San Jose, CA (US)

Correspondence Address: BUCKLEY, MASCHOFF, TALWALKAR LLC, 5 ELM STREET, NEW CANAAN, CT, 06840, US

(21) Appl. No.: 11/015,776

(22) Filed: Dec. 17, 2004

(51) Int. Cl. H04N 11/02; H04N 7/12; H04N 11/04; H04B 1/66

(52) U.S. Cl. 375/240.16; 375/240.24; 375/240.12

(57) ABSTRACT

According to some embodiments, a first value of a first parameter type is received in connection with a macroblock that represents a portion of an image. The macroblock may be divided into a first set of sub-portions, and different values of the first parameter type may be associated with different sub-portions of the first set. The first value may then be stored in a context buffer that includes a first context area associated with the first parameter type and a second context area associated with a second parameter type. The first context area might be, for example, adapted to store fewer values for each parameter type as compared to the second context area.

### BACKGROUND

A media player may output moving images to a display device. For example, a media player might retrieve locally stored image information or receive a stream of image information from a media server (e.g., a content provider might transmit a stream that includes high-definition image frames to a television, a set-top box, or a digital video recorder through a cable or satellite network). In some cases, the image information is encoded to reduce the amount of data used to represent the image. For example, an image might be divided into smaller image portions, such as macroblocks, so that information encoded with respect to one image portion does not need to be repeated with respect to another image portion (e.g., because neighboring image portions may frequently have similar color and brightness characteristics). As a result, information about neighboring image portions may need to be locally stored and accessed by the media player when a particular image portion is decoded. As the size and shape of image portions become more complex, however, storing information about these neighboring image portions might require a significant amount of storage space or be otherwise impractical.

### BRIEF DESCRIPTION OF THE DRAWINGS

FIG. 1 is a block diagram of a media system.

FIG. 2 illustrates a display divided into macroblocks.

FIG. 3 illustrates a display divided into macroblocks, macroblock partitions, and sub-macroblocks.

FIG. 4 illustrates a single macroblock.

FIGS. 5 and 6 illustrate a macroblock divided into two macroblock partitions.

FIG. 7 illustrates a macroblock divided into four sub-macroblocks.

FIG. 8 illustrates sub-macroblocks divided into sub-macroblock partitions.

FIG. 9 is a block diagram of an apparatus according to some embodiments.

FIG. 10 is a flow diagram illustrating a method according to some embodiments.

FIG. 11 illustrates a portion of a context buffer according to some embodiments.

FIG. 12 illustrates context map numbering for group II parameters according to some embodiments.

FIGS. 13 through 17 illustrate context mapping for group II parameters in connection with macroblocks, macroblock partitions, and sub-macroblocks according to some embodiments.

FIG. 18 illustrates context map numbering for group III parameters according to some embodiments.

FIGS. 19 through 23 illustrate context mapping for group III parameters in connection with macroblocks, macroblock partitions, sub-macroblocks, and sub-macroblock partitions according to some embodiments.

FIG. 24 is a block diagram of a system according to some embodiments.

### DETAILED DESCRIPTION

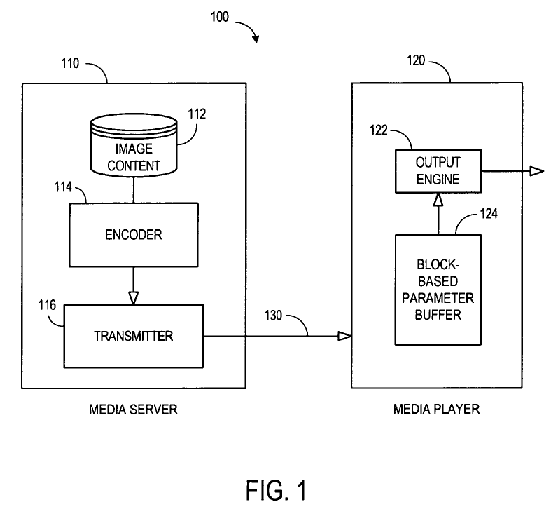

A media player may receive image information, decode the information, and output a signal to a display device. For example, a Digital Video Recorder (DVR) might retrieve locally stored image information, or a set-top box might receive a stream of image information from a remote device (e.g., a content provider might transmit a stream that includes high-definition image frames to the set-top box through a cable or satellite network). FIG. 1 is a block diagram of a media system 100 including a media server 110 that provides image information to a remote media player 120 through a communication network 130.

An encoder 114 may reduce the amount of data- that is used to represent image content 112 before the data is transmitted by a transmitter 116 as a stream of image information. As used herein, information may be encoded and/or decoded in accordance with any of a number of different protocols. For example, image information may be processed in connection with International Telecommunication Union-Telecommunications Standardization Sector (ITU-T) recommendation H.264 entitled “Advanced Video Coding for Generic Audiovisual Services” (2004) or the International Organization for Standardization (ISO)/International Engineering Consortium (IEC) Motion Picture Experts Group (MPEG) standard entitled “Advanced Video Coding (Part 10)” (2004). As other examples, image information may be processed in accordance with ISO/IEC document number 14496 entitled “MPEG-4 Information Technology—Coding of Audio-Visual Objects” (2001) or the MPEG2 protocol as defined by ISO/IEC document number 13818-1 entitled “Information Technology—Generic Coding of Moving Pictures and Associated Audio Information” (2000).

An image may be divided into smaller image portions, and information encoded with respect to one image portion might be re-used with respect to another image portion. As a result, an output engine 122 at the media player 120 may store information about neighboring portions into, and access that information from, a block-based parameter buffer 124 while decoding a received stream of image information. The block-based parameter buffer 124 might comprise, for example, a memory structure located locally at, or external to, the output engine 122.

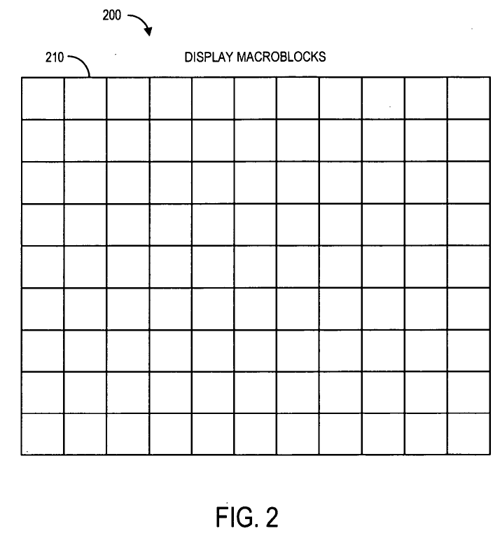

Consider, for example, H.264 image information. As illustrated in FIG. 2, a display image 200 may be divided into a number of “macroblocks” 210. Moreover, information about one macroblock 210 may be encoded using information about neighboring macroblocks (e.g., because neighboring macroblocks 210 may frequently have similar characteristics).

When a particular macroblock 210 is being decoded and/or decompressed, information about that macroblock 210 might therefore be derived using a predicted value from one or more neighboring blocks. In some cases, a predicted parameter is derived from a single neighboring block's parameter while in other cases it is derived from parameters associated with multiple neighboring blocks. A difference between the predicted value and the actual value may be determined from the received stream of image information and then be used by the output engine 122 to generate an output that represents the original image content 112.

As a result, information about neighboring macroblocks may be stored and accessed while a particular macroblock 210 is being decoded. As the size and partitioning of macroblocks become more complex, however, storing information about neighboring macroblocks might require a significant amount of storage space or be otherwise impractical.

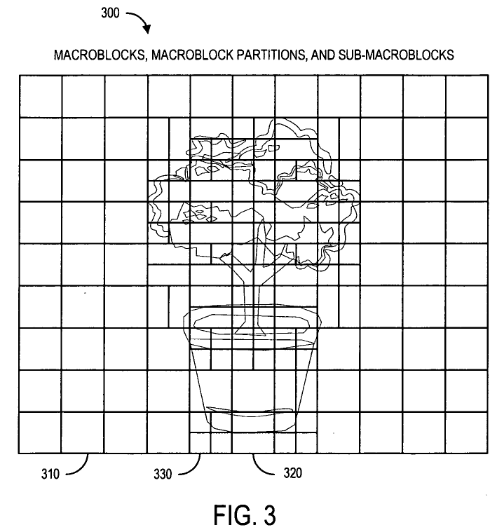

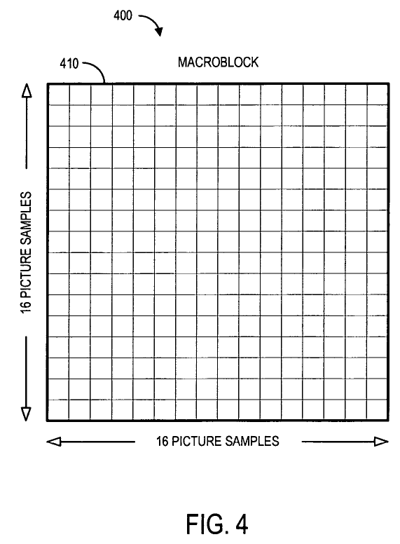

For example, FIG. 3 illustrates a display 300. In this case, portions of the display 300 that are substantially similar (e.g., a background area) might be encoded as macroblocks 310. Other portions that contain more detailed image information, however, might be further divided into macroblock partitions 320 and sub-macroblocks 330 as described with respect to FIGS. 4 through 7. Moreover, the display 300 may be divided in different ways as the image changes. Although this flexibility in partitioning may improve the compression and/or the quality of an image presented to a viewer, storing and accessing information about neighboring areas of the display 300 can be complex. Moreover, it may substantially increase the amount of on-chip storage structures (e.g., buffers) that are needed to store neighboring parameter values.

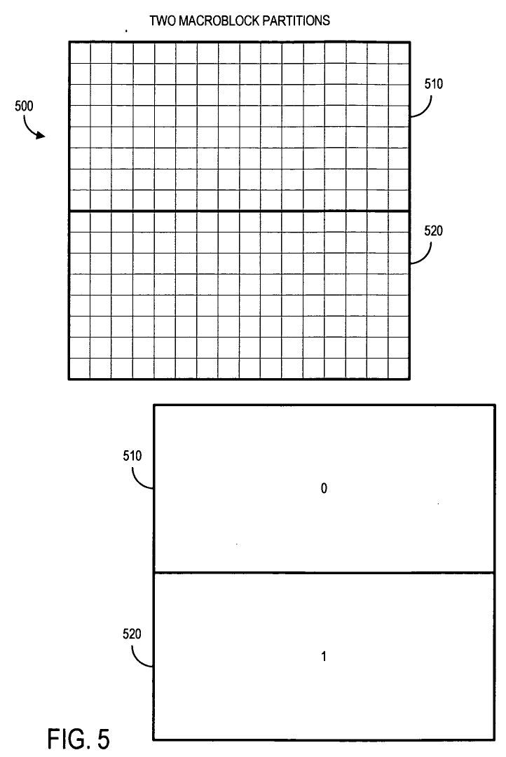

FIG. 4 illustrates a single macroblock 400 which represents a 16×16 set of image information samples (e.g., a total of 256 picture samples or pixels). Each macroblock 400 may be further divided into macroblock partitions. For example, as illustrated in FIG. 5 a single macroblock 500 may be divided into a first macroblock partition 510 (e.g., representing 16×8 samples in the top half of the macroblock 500) and a second macroblock partition 520 (representing 16×8 samples in the bottom half of the macroblock 500). In accordance with H.264, the first macroblock partition 510 is labeled “0” while the second macroblock partition 520 is labeled “1”

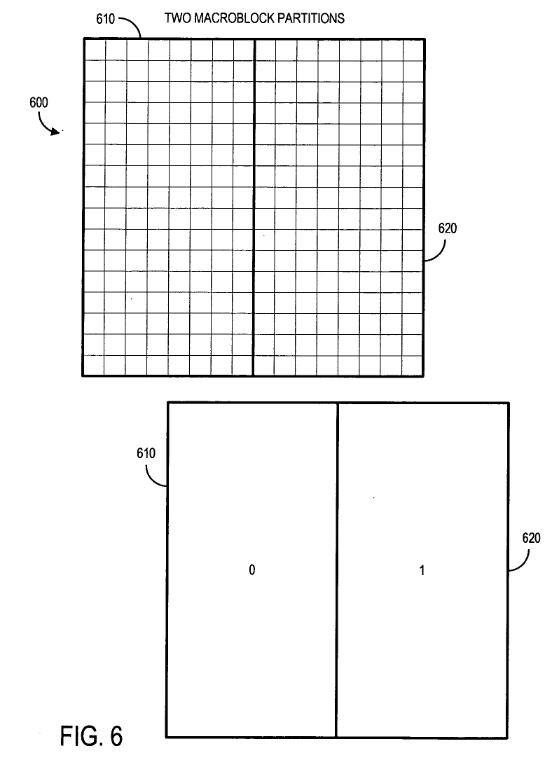

Depending on the original image, a macroblock might instead be partitioned as illustrated in FIG. 6. In this case, a macroblock 600 is divided into a first macroblock partition 610 (e.g., representing 8×16 samples in the left half of the macroblock 600) and a second macroblock partition 620 (representing 8×16 samples in the right half of the macroblock 600). As before, the first macroblock partition 610 is labeled “0” while the second macroblock partition 620 is labeled “1.”

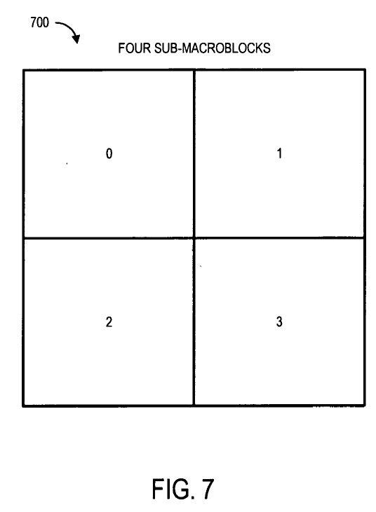

More complex areas of a display can be further divided into sub-macroblocks as illustrated in FIG. 7. In this case, a macroblock 700 is divided into (i) a first sub-macroblock numbered “0” (e.g., representing 8×8 samples in the upper-left quadrant of the macroblock 700); (ii) a second sub-macroblock numbered “1” (e.g., representing 8×8 samples in the upper-right quadrant of the macroblock 700); (iii) a third sub-macroblock partition numbered “2” (e.g., representing 8×8 samples in the lower-left quadrant of the macroblock 700); and (iv) a fourth sub-macroblock partition numbered “3” (e.g., representing 8×8 samples in the lower-right quadrant of the macroblock 700).

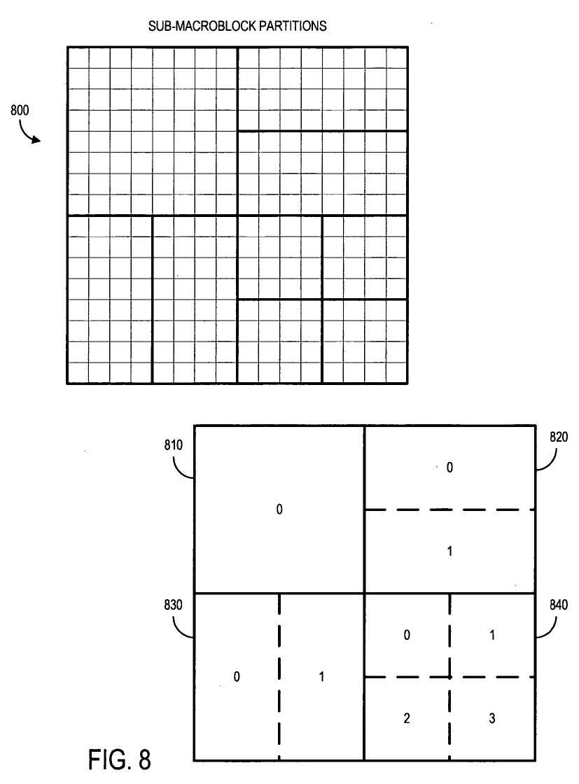

Each of these sub-macroblocks can be further divided as illustrated in FIG. 8. Here, a single macroblock 800 has been divided into four sub-macroblocks 810, 820, 830, 840 as described with respect to FIG. 7. In addition, the second sub-macroblock 820 has been divided into two sub-macroblock partitions, each representing an 8×4 set of samples. Similarly, the third sub-macroblock 830 has been divided into two sub-macroblock partitions each representing a 4×8 set of samples. Finally, the fourth sub-macroblock 840 has been divided into four sub-macroblock partitions, each representing a 4×4 set of samples from the original macroblock 800. As before, numbers in accordance with H.264 have been provided to label these sub-macroblock partitions.

Note that different types of image parameters may be defined with respect to different size areas of a macroblock. For example, some types of image parameters might always apply to a whole macroblock, other types might apply to a particular sub-macroblock (or macroblock partition), and still others might apply to a sub-macroblock partition.

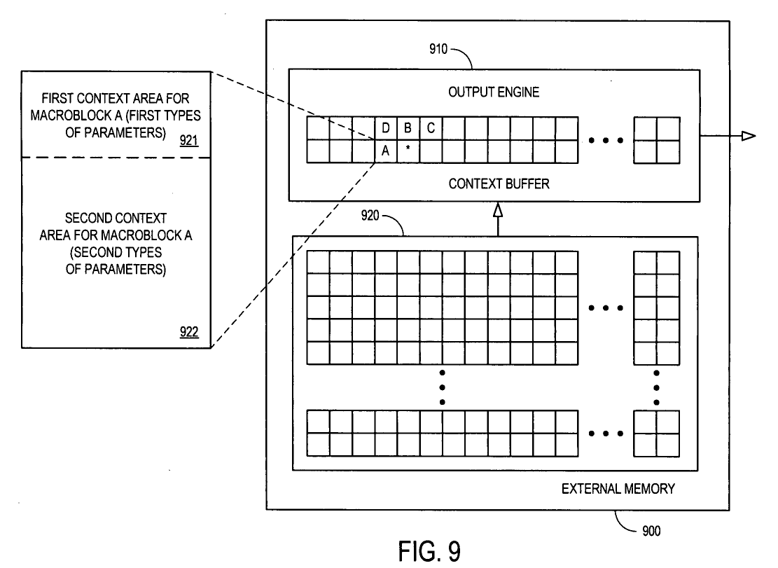

FIG. 9 is a block diagram of an apparatus 900 according to some embodiments. The apparatus 900 might be associated with, for example, a media player, a television, a Personal Computer (PC), a game device, a DVR, and/or a set-top box. The apparatus 900 includes an output engine 910. The output engine 910 may, for example, decode a stream of image information and generate an output to be provided to a display device.

To decode the image information, the output engine 910 may store information into and/or access information from a local context buffer. For example, the context buffer might store H.264 parameters associated with macroblocks A, B, C, and D adjacent to the macroblock * currently being decoded. The context buffer may also store information about additional macroblocks (e.g., an entire row of macroblock information might be stored in the context buffer). According to some embodiments, the context buffer is formed on the same die as the output engine 910. A memory unit 920 external to the output engine 910 may also be provided and may store information in accordance with any of the embodiments described herein. The external memory unit 920 may be, for example, a Double Data Rate (DDR) Synchronous Dynamic Random Access Memory (SDRAM) unit.

According to some embodiments, the context buffer and/or the external memory unit 920 includes a first context area 921 associated with a first type of parameter. In particular, the macroblock being decoded is potentially divisible into a first set of sub-portions, and different values of the first parameter type may be associated with different sub-portions of the first set. By way of example, parameters that can specified to a sub-macroblock level (e.g., a particular 8×8 sample area) might be stored in the first context area 921.

Similarly, the context buffer and/or the external memory unit 920 includes a second context area 922 associated with a second type of parameter for that macroblock. In this case, the macroblock can also be divided into a second set of sub-portions, wherein different values of the second parameter type may be associated with different sub-portions of the second set. Moreover, the number of sub-portions in the second set may be greater than the number of sub-portions in the first set. For example, parameters that can be specified to a particular sub-macroblock level (e.g., a particular 4×4 sample area) might be stored in the second context area 922. Note that although two context areas 921, 922 are illustrated in FIG. 9, embodiments may be associated with more than two context areas (e.g., three context areas might be provided to store H.264 information). Also note that although a single set of context areas 921, 922 for macroblock A is illustrated in FIG. 9, similar context areas may be provided for each macroblock in the context buffer and/or external memory unit 920.

Moreover, the context areas 921, 922 may not be contiguous. For example, the first context area 921 might be physically stored between portions of the second context area 922. Moreover, the first context area of one macroblock might physically stored remote from the first context area of another macroblock.

The output engine 910 may then decode received image information (e.g., received from a remote media server or a local storage device) in accordance with information in the context buffer (e.g., based in part on parameter values from context areas of neighboring macroblocks). According to some embodiments, the context buffer is located on the same die as the output engine 910.

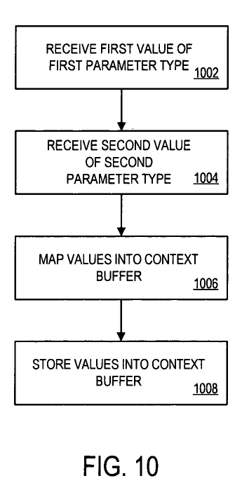

FIG. 10 is a flow diagram illustrating a method according to some embodiments. The method may be performed, for example, by the output engine 910 of FIG. 9. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 1002, a first value of a first parameter type is received. The first parameter type might be associated with, for example, a macroblock representing a portion of an image. Moreover, the macroblock is divisible into a first set of sub-portions (e.g., sub-macroblocks), and different values of the first parameter type might be associated with different sub-portions of the first set.

At 1004, a second value of a second parameter type is received for the macroblock. The macroblock is also divisible into a second set of sub-portions (e.g., sub-macroblock partitions), and different values of the second parameter type might be associated with different sub-portions of the second set. In addition, sub-portions of the first set represent a larger area of the image as compared to sub-portions of the second set.

At 1006, the first and second parameter types are mapped into a context buffer. In particular, the context buffer has a first context area associated with the first parameter type and a second context area associated with the second parameter type. Moreover, the first context area is adapted to store fewer values for each parameter type as compared to the second context area.

The first value may then be stored into the first context area and the second value may be stored into the second context area at 1008 based on the mapping. According to some embodiments, information in the context buffer is then used to decode the macroblock and to generate an output associated with the image.

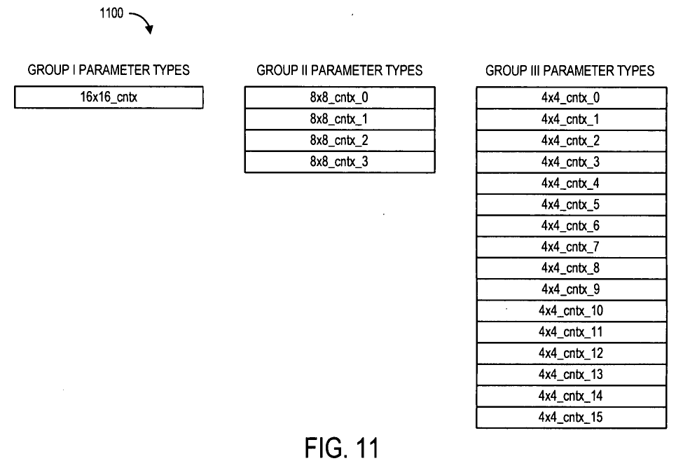

FIG. 11 illustrates a portion of a context buffer 1100 that may be used to store parameters for a macroblock according to some embodiments. In particular, the context buffer 1100 is adapted to store three different types of parameters. These numbers may now be used to name and/or map a group II parameter value to a context buffer area on a macroblock, a macroblock partition, and/or a sub-macroblock basis. Note that the context buffer 1100 may store the information illustrated in FIG. 11 for multiple macroblocks.

The first type of parameter in the context buffer 1100 is referred to herein as a “group I” parameter. A group I parameter may be, for example, a parameter that can only be defined on a macroblock basis. That is, a single value for that parameter will always apply to an entire macroblock. As a result, only a single value or “context” for each of parameter of this type needs to be stored in the context buffer 1100. With respect to H.264 decoding, examples of group I parameters might include SKIPMB (e.g., the macroblock is to be skipped), PMODE (e.g., intra or inter prediction mode information), and/or INTRLCMB (e.g., frame or field mode information associated with the macroblock).

The second type of parameter stored in the context buffer 1100 is referred to herein as a “group II” parameter. A group II parameter might be, for example, a parameter that can apply to samples that map to an 8×8 area irrespective of actual macroblock partitioning. That is, up to four different values for this type of parameter can apply to a macroblock. Thus, four values or “contexts” for each of these parameters are stored in the context buffer 1100 (e.g., cntx_{—}0 through cntx_{—}3). With respect to H.264 decoding, examples of group II parameters might included a reference index and/or an inference flag.

The third type of parameter stored in the context buffer 1100 is referred to herein as a “group III” parameter. A group III parameter might be, for example, a parameter that can apply to samples that map to a 4×4 area irrespective of actual macroblock partitioning. That is, up to sixteen values for that parameter could apply to a macroblock. Thus, sixteen values or “contexts” for each of these parameters are stored in the context buffer 1100 (e.g. cntx_{—}0 through cntx_{—}15). With respect to H.264 decoding, examples of group III parameters might included motion vectors in the x or y direction, intra prediction mode information, and/or a coded bit flag.

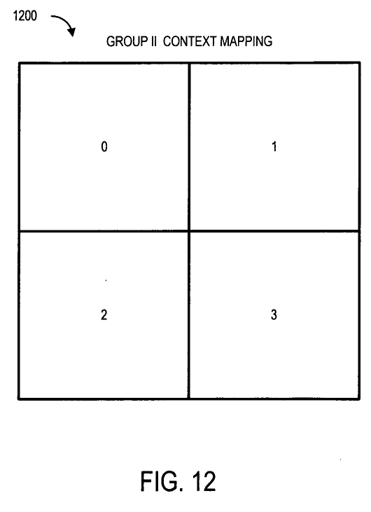

By partitioning the parameter or context buffer 1100 in this way, embodiments may reduce the amount of storage structures that are used to facilitate decoding. Some ways to map parameter values into and out of the context buffer 1100 will now be described with respect to FIGS. 12 through 22.

FIG. 12 illustrates context map numbering 1200 for group II parameters according to some embodiments. In particular, each of the four potential sub-macroblocks in the macroblock are numbered from “0” through “3.”

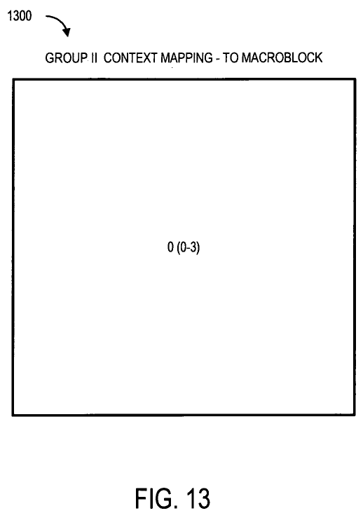

Although four different values of a group II parameter could potentially apply to a single macroblock, in some cases a single value will apply to the whole macroblock (e.g., when the macroblock is associated with a background area of an image and a larger partition is chosen). In this case, the single value will be stored into all four contexts in the context buffer (e.g., as illustrated by “(1-3)” in the mapping 1300 illustrated in FIG. 13). For example, the value may be written into cntx_{—}0 through cntx_{—}3 in the portion of the context buffer that is reserved for that parameter. Moreover, this set of four values may be named “0” based on the label of the sub-macroblock (as defined in FIG. 12) beneath the upper left hand corner of the macroblock.

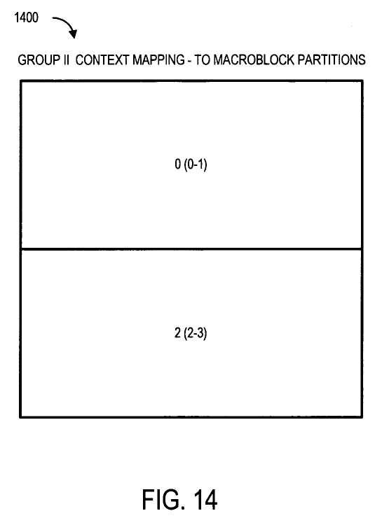

Similarly, a single group II parameter value might apply to an entire macroblock partition. Consider, for example, FIG. 14 which illustrates mapping 1400 when the macroblock has been divided into two horizontal partitions 0 and 2 (again named based on the label of the sub-macroblock beneath the upper left hand corner of the macroblock partition). In this case, the value of the macroblock partition 0 is mapped to contexts 0 and 1 and the value of macroblock partition 2 is mapped to contexts 2 and 3. Note that a single group II parameter value has been mapped to, and stored into, multiple contexts.

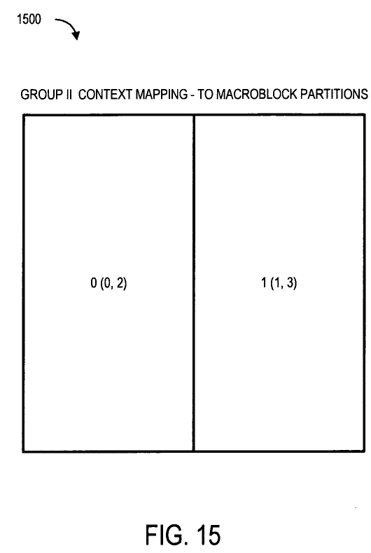

FIG. 15 illustrates mapping 1500 when the macroblock has been divided vertically into two partitions 0 and 1 (again named based on the label of the sub-macroblock beneath the upper left hand corner of the macroblock partition). In this case, the value of the macroblock partition 0 is mapped to contexts 0 and 2 and the value of macroblock partition 1 is mapped to contexts 1 and 3.

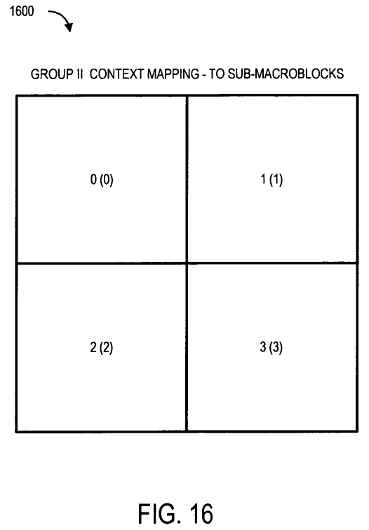

When the macroblock is divided into four different sub-macroblocks, each of the four contexts for a group II parameter may store a different value. For example, FIG. 16 illustrates mapping 1600 such that context 0 stores the value for sub-macroblock 0, context 1 stores the value for sub-macroblock 1, context 2 stores the value for sub-macroblock 2, and context 3 stores the value for sub-macroblock 3.

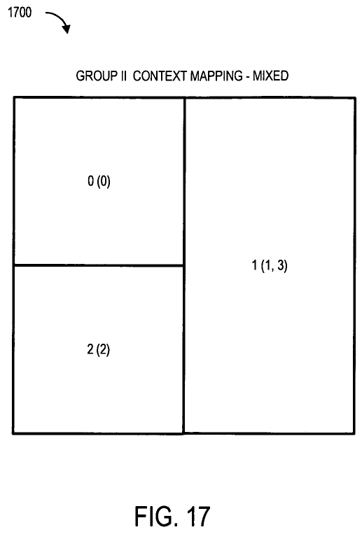

FIG. 17 illustrates mapping 1700 when different parts of a macroblock are partitioned in different ways. In particular, the upper left and lower left sub-macroblocks map into contexts 0 and 2, respectively. The two right macroblocks form partition 0, and the value of partition 0 is mapped to contexts 0 and 2.

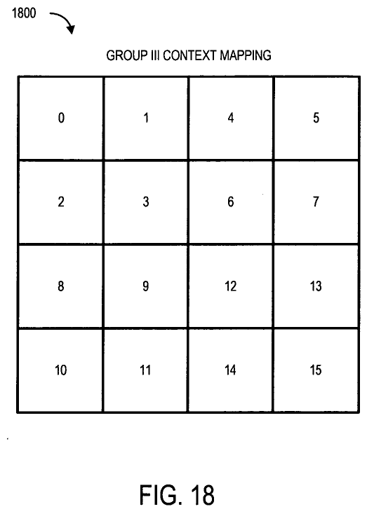

FIG. 18 illustrates -context map numbering 1800 for group III parameters according to some embodiments. In particular, each of the sixteen potential sub-macroblock partitions in the macroblock are numbered from “0” through “15.” These numbers may now be used to name and/or map a group III parameter value into a context buffer area on a macroblock, a macroblock partition, a sub-macroblock, and/or a sub-macroblock partition basis.

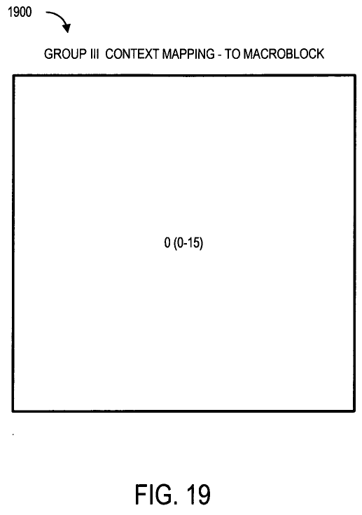

Although sixteen different values for a group III parameter could potentially apply to a single macroblock, in some cases a single value will apply to the whole macroblock (e.g., when the macroblock is associated with a background area of an image). In this case, the single value will be stored into all sixteen contexts in the context buffer (e.g., as illustrated by “(1-15)” in the mapping 1900 illustrated in FIG. 19). Moreover, this set of sixteen values may be named “0” based on the label of the sub-macroblock partition (as defined in FIG. 18) beneath the upper left hand corner of the macroblock.

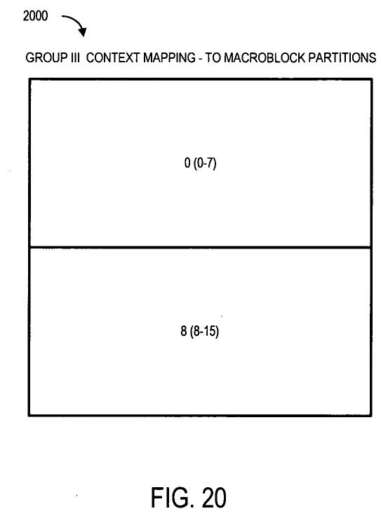

Similarly, a single group III parameter value might apply to an entire macroblock partition. Consider, for example, FIG. 20 which illustrates mapping 2000 when the macroblock has been divided into two horizontal partitions 0 and 8 (again named based on the label of the sub-macroblock partition beneath the upper left hand corner of the macroblock partition). In this case, the value of the macroblock partition 0 is mapped to contexts 0 through 7 and the value of macroblock partition 8 is mapped to contexts 8 through 15. Note that a single group III parameter has been mapped to, and stored into, multiple contexts.

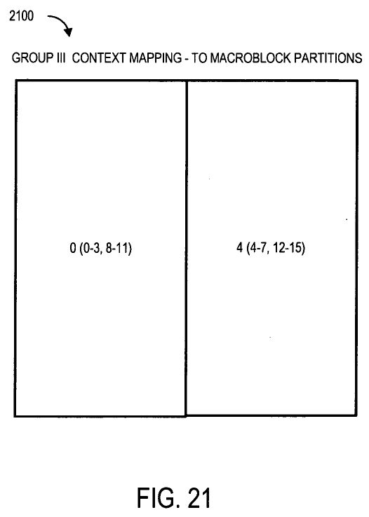

FIG. 21 illustrates mapping 2100 when the macroblock has been divided vertically into two partitions 0 and 4 (again named based on the label of the sub-macroblock partition beneath the upper left hand corner of the macroblock partition). In this case, the value of the macroblock partition 0 is mapped to contexts 0 through 3 and 8 through 11, and the value of macroblock partition 4 is mapped to contexts 4 through 7 and 12 through 15.

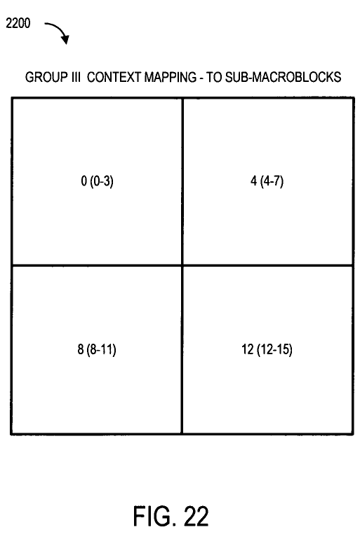

A group III parameter might also be defined to a sub-macroblock level. In this case, as illustrated by the mapping 2200 of FIG. 22, sub-macroblock 0 would map to contexts 0 through 3, sub-macroblock 4 would map to contexts 4 through 7, sub-macroblock 8 would map to contexts 8 through 11, and sub-macroblock 12 would map to contexts 12 through 15.

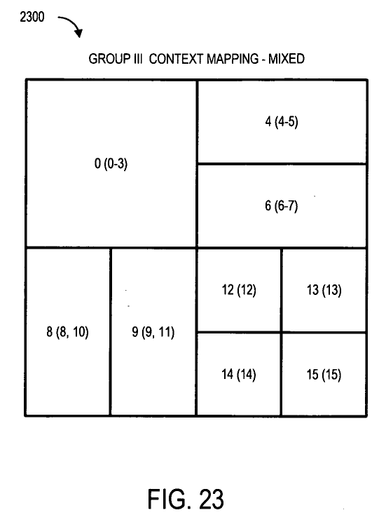

Finally, FIG. 23 illustrates mapping 2300 when different sub-macroblocks in a macroblock are partitioned in different ways. In particular, the upper left sub-macroblock has not been partitioned and therefore maps into contexts 0 through 3. The upper right sub-macroblock has been partitioned into sub-macroblock partition 4 (mapping into contexts 4 and 5) and sub-macroblock partition 6 (mapping into contexts 6 and 7).

The lower left sub-macroblock has been partitioned into sub-macroblock partition 8 (mapping into contexts 8 and 10) and sub-macroblock partition 9 (mapping into contexts 9 and 11). The lower right sub-macroblock has been partitioned into four sub-macroblock partitions 12 through 15, each being stored in the associated context. At worst, a single group III parameter will be associated with sixteen different values (not illustrated in FIG. 23). In this case, each value would be stored in a different context.

Note that the mapping described with respect to FIGS. 11 through 23 may be used either to store information into, or to retrieve information from, a context buffer. Moreover, according to some embodiments tables and/or logic circuits can be used to implement the mapping scheme.

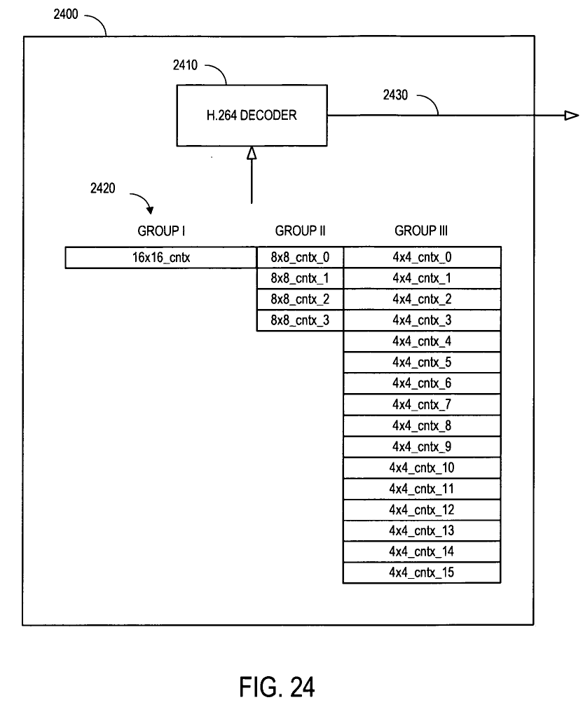

FIG. 24 is a block diagram of a system 2400 according to some embodiments. The system 2400 might be associated with, for example, a digital display device, a television such as a High Definition Television (HDTV) unit, a DVR, a game console, a PC or laptop computer, and/or a set-top box (e.g., a cable or satellite decoder).

The system 2400 includes a data storage device 2420, such as an on-chip buffer or an external SDRAM unit, that may operate in accordance with any of the embodiments described herein. For example, the data storage device 2420 may include an overall area storage portion associated with an overall area parameter type for a moving image area (e.g., a macroblock), wherein a single value of the overall area parameter type is to be associated with the image area. The overall area storage portion might, for example, be used to store group I H.264 parameter values as described herein.

The data storage device 2420 may also include a first storage portion associated with a first parameter type for the image area, the image area being potentially divisible into a first set of sub-areas. Note that different values of the first parameter type may be associated with different sub-areas of the first set. The first storage portion might, for example, be used to store group II H.264 parameter values as described herein (e.g., which can apply to a sub-macroblock). The data storage device 2420 may further include a second storage portion associated with a second parameter type for the image area, the image area being potentially divisible into a second set of sub-areas. Moreover different values of the second parameter type may be associated with different sub-areas of the second set. Note that the number of sub-areas in the second set may be different than the number of sub-areas in the first set. The second storage portion might, for example, be used to store group III H.264 parameter values as described herein (e.g., which can apply to a sub-macroblock partition). The data storage device may store the first, second, and third portions illustrated in FIG. 24 for multiple macroblocks (e.g., a macroblock currently being constructed, neighboring macroblocks, and/or additional macroblocks).

The system 2400 may further include an output engine 2410, such as an H.264 decoder, to decode a received stream of image information in accordance with information in the data storage device 2420. For example, the output engine 2410 may decode an H.264 macroblock, or portion of an H.264 macroblock, based at least in part on parameters associated with neighboring areas of the display. According to some embodiments, the output engine 2410 generates information that is provided to a display device via a digital output 2430.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although a particular context buffer numbering and mapping scheme has been described herein, embodiments may be associated with any other types of buffer numbering and mapping techniques. For example, a particular decoding approach might include different sized blocks of image information than those that have been described herein as examples.

Moreover, although particular image processing protocols and networks have been used herein as examples (e.g., H.264 and MPEG4), embodiments may be used in connection any other type of image processing protocols or networks, such as Digital Terrestrial Television Broadcasting (DTTB) and Community Access Television (CATV) systems.

The several embodiments described herein are solely for the purpose of illustration. Persons skilled in the art will recognize from this description other embodiments may be practiced with modifications and alterations limited only by the claims.

What is claimed is:

1. A method, comprising:
receiving a first value of a first parameter type associated with a macroblock representing a portion of an image, the macroblock being potentially divisible into a first set of sub-portions, wherein different values of the first parameter type may be associated with different sub-portions of the first set; and
storing the first value in a context buffer, the context buffer including a first context area associated with the first parameter type and a second context area associated with a second parameter type, the first context area being adapted to store fewer values for each parameter type as compared to the second context area.

2. The method of claim 1, further comprising:
receiving a second value of the second parameter type associated with the macroblock, the macroblock further being potentially divisible into a second set of sub-portions, wherein different values of the second parameter type may be associated with different sub-portions of the second set and wherein sub-portions of the first set represent a larger area of the image as compared to sub-portions of the second set; and
storing the second value in the context buffer.

3. The method of claim 2, further comprising:
receiving a third value of a third parameter type associated with the entire macroblock; and
storing the third value in a third context area of the context buffer, the third context area being adapted to store a single value for each parameter type.

4. The method of claim 2, further comprising:
mapping the first and second parameter types into the context buffer; and
storing the first value in the first context area and the second value in the second context area of the context buffer in accordance with the mapping.

5. The method of claim 4, wherein said mapping comprises:
mapping the first value to areas of the first context associated with a plurality of sub-portions in the first set.

6. The method of claim 4, wherein said mapping further comprises:
mapping the second value to areas of the second context associated a plurality of sub-portions in the second set.

7. The method of claim 1, wherein the macroblock is associated with at least one of: (i) H.264 information, (ii) Motion Picture Experts Group 2 information, or (iii) Motion Picture Experts Group 4 information.

8. The method of claim 1, wherein the macroblock is an H.264 macroblock, and each of the first set of sub-portions represent a sub-macroblock of 8×8 picture samples.

9. The method of claim 8, wherein each of the second set of sub-portions represent a sub-macroblock partition of 4×4 picture samples and associated chroma samples.

10. The method of claim 1, wherein said receiving is associated with at least one of: (i) a digital display device, (ii) a television, (iii) a digital video recorder, (iv) a game device, (v) a personal computer, or (vi) a set-top box.

11. An apparatus, comprising:
a context buffer, including:
a first context area associated with a first parameter type for a macroblock representing a portion of an image, the macroblock being potentially divisible into a first set of sub-portions, wherein different values of the first parameter type may be associated with different sub-portions of the first set, and
a second context area associated with a second parameter type for the macroblock, the macroblock being potentially divisible into a second set of sub-portions, wherein different values of the second parameter type may be associated with different sub-portions of the second set, and wherein the number of sub-portions in the first set is less than the number of sub-portions in the second set; and
an output engine to decode a received stream of image information in accordance with information in the context buffer.

12. The apparatus of claim 1 1, wherein the context buffer is at least one of: (i) located on the same die as the output engine or (ii) located external to the output engine.

13. The apparatus of claim 1 1, wherein the output engine comprises a decoding engine.

14. An apparatus comprising:
a storage medium having stored thereon instructions that when executed by a machine result in the following:
receiving a first value of a first parameter type associated with an H.264 macroblock representing a portion of an image, the macroblock being potentially divisible into four sub-macroblocks, wherein different values of the first parameter type may be associated with different sub-macroblocks,
receiving a second value of a second parameter type associated with the macroblock, the macroblock further being potentially divisible into sixteen sub-macroblock partitions, wherein different values of the second parameter type may be associated with different sub-macroblock partitions, and
storing the first and second values in a context buffer, the context buffer including a first context area associated with the first parameter type and a second context area associated with the second parameter type, the first context area being adapted to four values for the first parameter type and the second context area being adapted to store sixteen values for the second parameter type.

15. The apparatus of claim 14, wherein execution of the instructions further results in:
mapping the first and second parameter types into the context buffer, and
storing the first value in the first context area and the second value in the second context area of the context buffer in accordance with the mapping.

16. The apparatus of claim 15, wherein the first parameter type is associated with at least one of: (i) a reference index, or (ii) an inference flag.

17. The apparatus of claim 16, wherein the second parameter type is associated with at least one of: (i) an x-direction motion vector, (ii) a y-direction motion vector, (iii) an intra-prediction mode, or (iv) a coded bit flag.

18. A system, comprising:
a data storage device, including:
an overall area storage portion associated with an overall area parameter type for a moving image area, wherein a single value of the overall area parameter type is to be associated with the image area,
a first storage portion associated with a first parameter type for the image area, the image area being potentially divisible into a first set of sub-areas, wherein different values of the first parameter type may be associated with different sub-areas of the first set, and
a second storage portion associated with a second parameter type for the image area, the image area being potentially divisible into a second set of sub-areas, wherein different values of the second parameter type may be associated with different sub-areas of the second set, and wherein the number of sub-areas in the second set is different than the number of sub-areas in the first set;
an output engine to decode a received stream of image information in accordance with information in the data storage device; and
a digital output to provide a digital signal from the output engine to a digital display device.

19. The system of claim 18, wherein the data storage unit is a double-data-rate random access memory unit.

20. The system of claim 18, wherein the data storage unit is part of the output engine.

21. The system of claim 18, wherein the system is associated with at least one of: (i) a digital display device, (ii) a television, (iii) a digital video recorder, (iv) a game device, (v) a personal computer, or (vi) a set-top box.
